(19) United States
(12) Patent Application Publication
(10) Pub. No.: US 2004/0131768 A1
(43) Pub. Date: Jul. 8, 2004

(54) Manufacturing method for membrane electrode assembly for solid polymer fuel cell

(75) Inventors: Gang Xie, Anjo-shi (JP); Satoshi Oowada, Obu-shi (JP); Koji Tatematsu, Nagoya-shi (JP); Koji Ueyama, Handa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/668,159

(22) Filed: Sep. 24, 2003

(30) Foreign Application Priority Data
Sep. 24, 2002 (JP) 2002-277820

(51) Int. Cl. B05D 5/12; H01M 8/10

(52) U.S. Cl. 427/115; 429/30

(57) ABSTRACT

A method for manufacturing a membrane electrode assembly for a solid polymer type fuel cell which includes a process for forming an intermediate lamination layer body by laminating a catalyst electrode layer on an electrolyte membrane including an ion conductivity, and a process for hot pressing for forming the membrane electrode assembly to unify the intermediate lamination layer body and porous gas diffusion layers positioned on both sides on the intermediate lamination layer body in a thickness direction. The intermediate lamination layer body is heat treated by maintaining heating at a temperature range equal to or higher than a glass-transition temperature of the electrolyte polymer included in the catalyst electrode layer and equal to or lower than thermal decomposition temperature before the hot pressing process under a condition that the gas diffusion layers are not laminating on the intermediate lamination layer body.

This application is based on and claims priority under 35 U.S.C. § 119 with respect to Japanese Patent Application No. 2002-277820 filed on Sep. 24, 2002, the entire content of which is incorporated herein by reference.

### FIELD OF THE INVENTION

The present invention relates to a method for manufacturing a membrane electrode assembly for solid polymer fuel cell. More particularly, the present invention pertains to a method for manufacturing a membrane electrode assembly for solid polymer fuel cell including catalyst electrode layers on both sides of an electrolyte membrane having ion conductivity.

### BACKGROUND OF THE INVENTION

As shown in FIG. 3, a membrane electrode assembly (MEA) of a solid polymer type fuel cell includes a catalyst electrode layer 110 for an oxidant electrode on a first side of an electrolyte membrane 100 having ion conductivity, a catalyst electrode layer 120 for a fuel electrode on a second side of the electrolyte membrane 100, a gas dispersion layer 111 for the oxidant electrode on an outer side of the catalyst electrode layer 110 for the oxidant electrode, and a gas dispersion layer 121 for the fuel electrode on the outer side of the catalyst electrode layer 120 for the fuel electrode. The membrane electrode assembly highly influences on the power generation performance of the solid polymer type fuel cell.

Generally, the MEA of the solid polymer type fuel cell is manufactured in the following process. The catalyst electrode layers 110, 120 made of a mixture primarily including electrolyte polymer solution having the ion conductivity and carbon miniature bodies such as carbon black having catalyst are laminated on the electrolyte membrane 100 having the ion conductivity to form an intermediate lamination body. Thereafter, the gas dispersion layers 111, 121 such as highly porous carbon paper or carbon cloth or the like are positioned on the both sides of the intermediate lamination body in the thickness direction to be formed as one unit by hot pressing.

By unitary combining the diffusion layers 111, 121 and the intermediate lamination body by hot pressing, the interface resistance between the electrolyte membrane 100 and the catalyst electrode layers 110, 120 respectively is reduced and the movement of the proton at the interface assumes favorable.

A method for manufacturing an assembly of the solid polymer membrane and the electrode is described in Japanese Patent Laid-Open Publication No. 3-208260. According to Japanese Patent Laid-Open Publication No. 3-208260, hot pressing is performed after applying the solution of the solid polymer electrolyte on at least one of two gas dispersion electrodes in order to manufacture an assembly of two gas dispersion electrodes including a reaction layer and a gas dispersion layer on the both sides of the solid polymer electrolyte membrane in the thickness direction.

A method for applying hot pressing on the ion exchange membrane including a copolymer of perfluoro vinyl ether and tetrafluoro ethylene at the temperature of 160-220° C. is described in Japanese Patent Laid-Open Publication No. 11-224679.

With Japanese Patent Laid-Open Publication No. 11-224679, the membrane having proton conductivity is sandwiched by two gas dispersion electrodes, is pressed with the pressure equal to or less than the assembling pressure until reaching the assembling temperature, and is pressed at the assembling temperature to increase the assembling condition between the membrane and the gas dispersion electrode, thus to reduce the contact resistance between thereof.

With the solid polymer type fuel cell, the water is generated by the power generation reaction on the oxidant electrode side. In addition, the fuel gas (e.g., gas including hydrogen) and oxidant gas (e.g., air including the oxygen) may be humidified. It is because the power generation performance is declined if the electrolyte membrane 100 having the ion conductivity is excessively dried. With the membrane electrode assembly with the foregoing construction, the electrolyte polymer having the ion conductivity included in the catalyst electrode layers 110, 120 may not be sufficiently fixed and may be eluded by the generated water or the humidifying water generated through the power generation reaction. This deteriorates the membrane electrode assembly and the output potential of the solid polymer type fuel cell may be declined.

A need thus exists for a method for manufacturing the membrane electrode assembly for the solid polymer fuel cell advantageous for restraining the decline of the excessive output potential during the long hour power generation and advantageous for restraining the deterioration of the membrane electrode assembly.

### SUMMARY OF THE INVENTION

In light of the foregoing, the present invention includes a method for manufacturing a membrane electrode assembly for a solid polymer type fuel cell which includes a process for forming an intermediate lamination layer body by laminating a catalyst electrode layer formed with a mixture including electrolyte polymer having the ion conductivity and a conductive miniature body including a catalyst on an electrolyte membrane including an ion conductivity, and a process for hot pressing for forming the membrane electrode assembly to unify the intermediate lamination layer body and porous gas diffusion layers positioned on both sides on the intermediate lamination layer body in a thickness direction. The intermediate lamination layer body is heat treated by maintaining heating at a temperature range equal to or higher than a glass-transition temperature of the electrolyte polymer included in the catalyst electrode layer and equal to or lower than thermal decomposition temperature before the hot pressing process under a condition that the gas diffusion layers are not laminating on the intermediate lamination layer body.

According to another aspect of the present invention, a method for manufacturing a membrane electrode assembly for a solid polymer type fuel cell includes a process for forming an intermediate lamination layer body by laminating a catalyst electrode layer formed with a mixture of an electrolyte polymer having the ion conductivity and a conductive miniature body including a catalyst on a porous gas diffusion layer, and a process for hot pressing for forming a membrane electrode assembly by unifying an electrolyte membrane having the ion conductivity and the intermediate lamination layer bodies arranged both sides of the electrolyte membrane. The intermediate lamination layer body is heat treated by maintaining heating at a temperature range equal to or higher that glass-transition temperature of the electrolyte polymer included in the catalyst electrode layer and equal to or lower than the thermal decomposition temperature before the process of hot pressing under a condition that the electrolyte membrane is not laminated on the intermediate lamination layer body.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1A is a view showing a manufacturing process according to an embodiment of the present invention.

FIG. 1B is a view showing a manufacturing process according to the embodiment of the present invention.

FIG. 1C is a view showing a manufacturing process according to the embodiment of the present invention.

FIG. 1D is a view showing a manufacturing process according to the embodiment of the present invention.

FIG. 1E is a view showing a manufacturing process according to the embodiment of the present invention.

FIG. 1F is a view showing a manufacturing process according to the embodiment of the present invention.

FIG. 1G is a view showing a manufacturing process according to the embodiment of the present invention.

FIG. 2A is a view showing a manufacturing process according to another embodiment of the present invention.

FIG. 2B is a view showing a manufacturing process according to the embodiment of the present invention.

FIG. 2C is a view showing a manufacturing process according to the embodiment of the present invention.

FIG. 2D is a view showing a manufacturing process according to the embodiment of the present invention.

FIG. 2E is a view showing a manufacturing process according to the embodiment of the present invention.

FIG. 3 is a cross-sectional view showing an internal construction of a membrane electrode assembly.

### DETAILED DESCRIPTION OF THE INVENTION

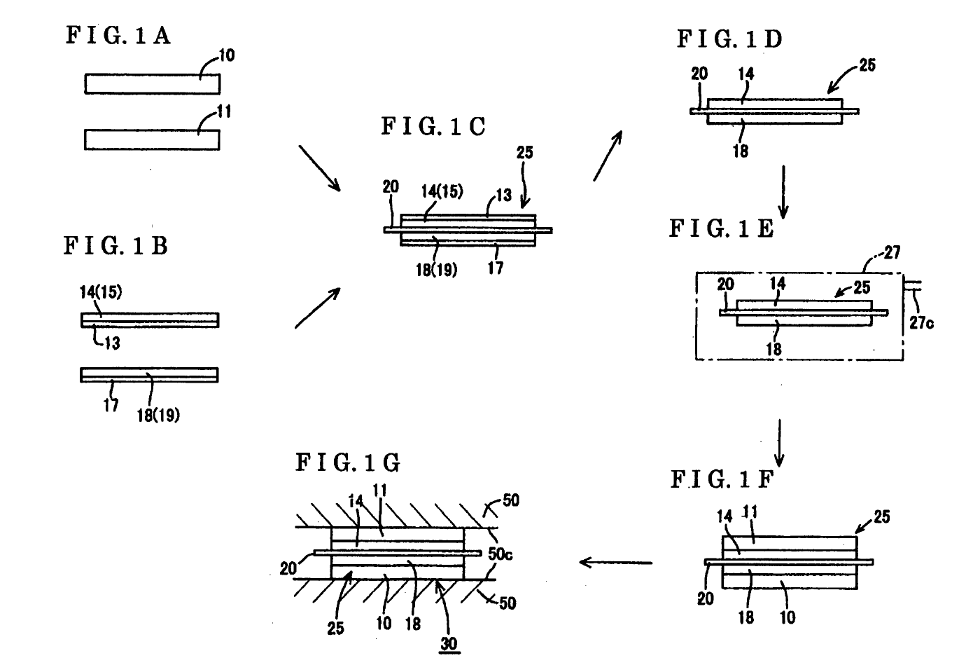

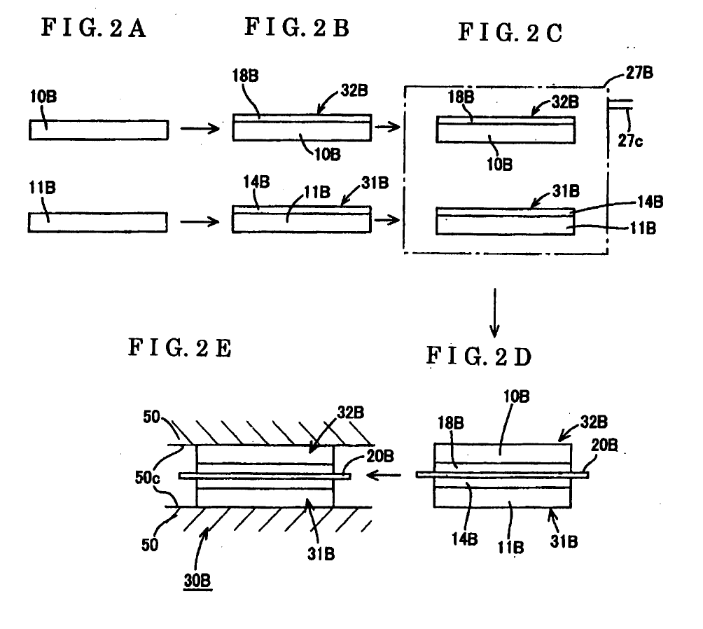

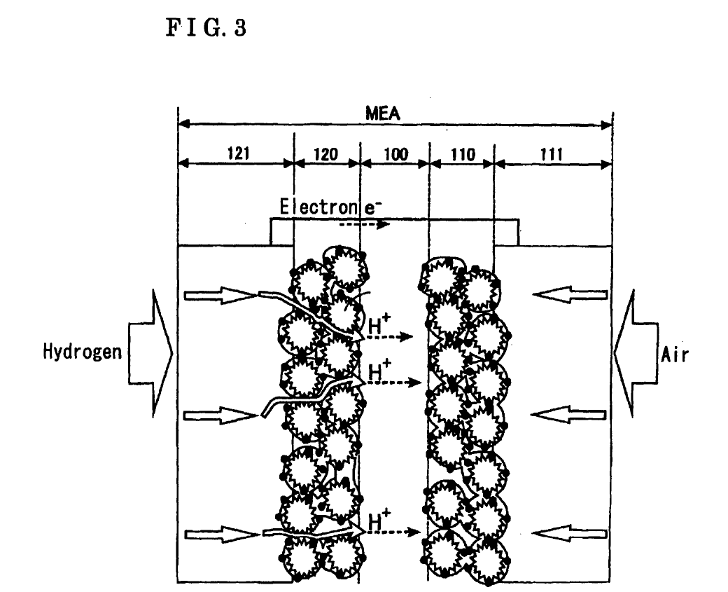

Embodiments of the present invention will be explained with reference to illustrations of FIGS. 1-2.

According to a first embodiment of the present invention, 300 g of carbon black (i.e., electric conductive material) is mixed with 1000 g of water to form the mixed solution. The mixed solution is mixed for 10 minutes by a mixer. Further, 250 g of dispersion undiluted solution including 60 percent concentration of tetra fluoro ethylene (PTFE) manufactured by Daikin Industries Ltd. (POLYFLON D1 grade) is mixed with the mixed solution. By further mixing the solution for ten minutes, the carbon ink is produced.

A carbon paper (Toray Industries Inc.; Torayca TGP-060, 180 μm) corresponding to a base material of the gas dispersion layer is soaked into the carbon ink to sufficiently infiltrate the PTFE dispersion undiluted solution. Then, excessive water of the carbon paper is evaporated in a drying oven in which the temperature is maintained at 80° C. Thereafter, the PTFE on the carbon paper is sintered at 390° C. maintained for 60 minutes to produce two water repellent carbon papers. The water repellent carbon papers are applied as the gas dispersion layer 10 for the fuel electrode and the gas dispersion layer 11 for the oxidant electrode.

The catalyst paste is formed in the following manner. Platinum supporting carbon (Tanaka Kikinzoku Kogyo K.K. TEC10E60E) including 55 wt percent concentration of platinum supporting carbon is used. The platinum supporting carbon is a carbon miniature body (i.e., electric conductive miniature body) supporting platinum functioning as the catalyst. The catalyst paste for the oxidant electrode is produced by mixing 12 g of platinum supporting carbon, 127 g of 5 wt percent concentration ion exchange resin solution (Asahi Kasei Corporation SS-1080), 23 g of water, and 23 g of isopropyl alcohol functioning as forming agent. The ion exchange resin solution mainly includes fluorine carbide electrolyte polymer (glass-transition temperature: 120° C.) having ion conductivity (i.e., proton conductivity) and is formed by dissolving or dispersing the fluorine carbide electrolyte polymer into the mixed solution of the water and ethanol functioning as the liquid medium. More particularly, the fluorine carbide electrolyte polymer mainly includes perfluoro sulfonic acid.

As shown in FIG. 1B, the catalyst paste formed in the foregoing manner is applied to a teflon sheet 13 by the doctor blade method to form a catalyst electrode layer 14 for the oxidant electrode. In this case, the platinum supporting amount of the catalyst electrode layer 14 is determined to be 0.6 mg/cm². Thereafter, the catalyst electrode layer 14 is dried to form an oxidant electrode sheet 15 (shown in FIG. 1B).

In place of the platinum supporting carbon, platinum (supporting concentration 30 wt percent) ruthenium (supporting concentration 23 wt percent) alloy supporting carbon (Tanaka Kikinzoku Kogyo K.K.; TEC61E54) corresponding to a carbon miniature body(electric conductive miniature body) supporting platinum and ruthenium is used. The catalyst paste for the fuel electrode is formed using the platinum ruthenium alloy supporting carbon with a method likewise the foregoing. The catalyst paste is applied to a teflon sheet 17 by the doctor blade method to form a catalyst electrode layer 18 (shown in FIG. 1B) for the fuel electrode. In this case, the platinum supporting amount at the catalyst electrode layer 18 is determined to be 0.6 mg/cm². Thereafter, the catalyst electrode layer 18 for the fuel electrode is dried to form a fuel electrode sheet 19 (shown in FIG. 1B).

An electrolyte membrane 20 including an ion exchange membrane (25μ of thickness, produced by Dupont, Nafion 111) having the ion conductivity is used. The oxidant electrode sheet 15 and the fuel electrode sheet 19 are arranged on the both sides of the electrolyte membrane 20 in the thickness direction to form an intermediate lamination layer body 25 having a sheet shape (shown in FIG. 1C). In this case, the electrolyte membrane 20 and the oxidant electrode sheet 15 and the fuel electrode sheet 19 are accumulated so that the surfaces of the catalyst electrode layers 14, 18 and the surface of the electrolyte membrane 20 contact. The intermediate lamination layer body 25 is preliminarily applied with the hot pressing under the condition with 120° C. of temperature, pressure of 8 MPa, for one minute to transfer the catalyst electrode layers 14, 18 to the electrolyte membrane 20. Then, the teflon sheets 13, 17 are peeled from the intermediate lamination layer body 25 (shown in FIG. 1D).

The sheet formed intermediate lamination layer body 25 including the catalyst electrode layer 14 and the catalyst electrode layer 18 is placed in a homoeothermic furnace (heat treatment oven) 27 (shown in FIG. 1E). The inactive gas (nitrogen gas) is introduced to the homoeothermic furnace 27 via an introduction pipe 27c. The intermediate lamination layer body 25 is heat treated by maintaining heating the intermediate lamination layer body 25 at an inactive gas ambient (pressure in the furnace: 0.1 Mpa) in the homoeothermic furnace 27 with the heat treatment condition at the temperature of 120° C. for 10 minutes. The inactive gas ambient is applied in order to restrain the oxidization of the catalyst and the electrolyte polymer by the oxygen. As shown in FIG. 1E, the intermediate lamination layer body 25 does not include the gas diffusion layers 10, 11 and is separated from the gas diffusion layers 10, 11 at the heat treatment.

The temperature for the heat treatment is determined at the temperature region equal to or greater than the glass-transition temperature of the electrolyte polymer having the ion conductivity (proton conductivity) included in the catalyst electrolyte layers 14, 18 and equal to or less than the thermal decomposition temperature. The pressure is not applied to the intermediate lamination layer body 25 in the thickness direction at the heat treatment. The pressure is not applied to the intermediate lamination layer body 25. The pressure is not applied to, the intermediate lamination layer body 25 at the heat treatment in order to minimize the damage to the electrolyte membrane 20. The ambient in the homoeothermic furnace 27 may be determined at the atmosphere.

As shown in FIG. 1E, heat treatment is applied to the intermediate lamination layer body 25 not including the gas diffusion layers 10, 11 (i.e., the condition that the gas diffusion layers 10, 11 are separated from the intermediate lamination layer body 25). Thus, the heat transmission to the catalyst electrode layer 14 and the catalyst electrode layer 18 is prevented by the gas diffusion layers 10, 11. Accordingly, the heat transmission performance to the electrolyte polymer included in the catalyst electrodes layers 14, 18 of the intermediate lamination layer body 25 is ensured at the heat treatment and the heat treatment relative to the electrolyte polymer can be favorably performed.

After the foregoing heat treatment, the intermediate lamination layer body 25 is removed from the homoeothermic furnace 27 (shown in FIG. 1F). The gas diffusion layer 10 for the fuel electrode and the gas diffusion layer 11 for the oxidant electrode are positioned at both sides of the intermediate lamination layer body 25 in the thickness direction after the heat treatment. The intermediate lamination layer body 25 is heated and pressured (applied with the hot pressing) with a pattern 50c of a hot pressing pattern 50 (shown in FIG. 1G) at the condition at the temperature of 140° C., at the pressure of 8 MPa for 3 minutes. Accordingly, a sheet formed MEA (membrane electrode assembly) 30 is produced.

According to the first embodiment of the present invention, t1 is determined to be 10/3 (approximately 3.3 times) of t2 (t1>t2) when the heat treatment is performed for a time t1 (e.g., 10 minutes) and a time for applying hot pressing is determined to be t2 (e.g., 3 minutes). When the temperature for the heat treatment is determined to be T1 (e.g., 120° C.) and the temperature for the hot pressing is determined to be T2 (e.g., 140° C.), the temperature T1 is determined to be slightly lower than the temperature T2.

According to the first embodiment, when the pressure loaded on the intermediate lamination layer body 25 at the heat treatment is determined to be P1 (no pressure applied) and the pressure loaded on the intermediate lamination layer body 25 at the hot pressing is determined to be P2 (e.g., 8 MPa), the pressure P1 is determined to be less than the pressure P2 (P1<P2).

According to the first embodiment of the present invention, the degree of crystallinity of the electrolyte polymer which is the main element of the catalyst electrode layers 14, 18 is promoted and thus the solidity is promoted. Accordingly, the solubility of the electrolyte polymer into the generated water and the humidification water can be declined at the operation of the solid polymer fuel cell. Accordingly, the effusion of the electrolyte polymer can be restrained and the output potential of the solid polymer type fuel cell can be maintained at high level even if the solid polymer type fuel cell can be operated for a long period.

A second embodiment of the present invention will be explained as follows. The second embodiment of the present invention is embodied likewise the first embodiment except some changes. The intermediate lamination layer body 25 transferring the catalyst electrode layer 18 for the fuel electrode and the catalyst electrode layer 14 for the oxidant electrode are placed in the homoeothermic furnace (i.e., heat treatment oven) for heat treating the intermediate lamination layer body 25 at the inactive gas ambient. The condition for the heat treatment is varied relative to the first embodiment of the present invention. The temperature for the heat treatment is determined to be higher than the temperature of the first embodiment (e.g., 140° C.) and the time for the heat treatment is determined to be the same with the first embodiment (e.g., 10 minutes). The temperature for the heat treatment is determined to be the temperature region equal to or greater than the glass-transition temperature of the electrolyte polymer having the ion conductivity (proton conductivity) included in the catalyst electrolyte layers 14, 18 and equal to or less than the thermal decomposition temperature. As shown in FIG. 1E, the intermediate lamination layer body 25 is separated from the gas diffusion layers 10, 11 and the gas diffusion layers 10, 11 are not included in the intermediate lamination layer body 25. The pressure is not applied to the intermediate lamination layer body 25 during the heat treatment.

According to the second embodiment of the present invention, the time for the heat treatment is determined to be a time t1 (e.g., 10 minutes) and the time for the hot pressing is determined to be a time t2 (e.g., 3 minutes), the time t1 is 10/3 times (Approximately 3.3 times) relative to the time t2 (i.e., t1>t2). Provided that the temperature for the heat treatment is determined to be T1 (e.g., 140° C.) and the temperature for the hot pressing is determined to be T2 (e.g., 140° C.), the temperature T1 and the temperature T2 are determined to be the same (T1=T2).

A third embodiment of the present invention will be explained as follows. The third embodiment of the present invention is embodied likewise the first embodiment except some changes. The intermediate lamination layer body 25 transferring the catalyst electrode layer 14 for the oxidant electrode and the catalyst electrode layer 18 fro the fuel electrode are placed in the homoeothermic furnace 27 for heat treating the intermediate lamination layer body 25 at the inactive gas ambient. The conditions for the heat treatment are changed relative to the first and the second embodiment of the present invention. The temperature for the heat treatment is determined to be higher than the temperature of the first and the second embodiments (e.g., 160° C.) and the time for the heat treatment is determined to be the same with the time for the first and the second embodiment (e.g., 10 minutes). The temperature for the heat treatment is determined to be at the temperature region equal to or greater than the glass-transition temperature of the electrolyte polymer included in the catalyst electrode layer 14 and the catalyst electrode layer 18 and equal to or less than the thermal decomposition temperature. The gas diffusion layers 10, 11 are not included in the intermediate lamination layer body 25 at the beat treatment. The pressure is not applied to the intermediate lamination layer body 25 at the heat treatment.

According to the third embodiment of the present invention, when the time for the heat treatment is determined to be t1 (e.g., 10 minutes) and the time for the hot pressing is determined to be t2 (e.g., 3 minutes), the time t1 is 10/3 times (approximately 3.3 times) to the time t2. If the temperature for the heat treatment is determined to be T1 (e.g., 160° C.) and the temperature of the hot pressing is determined to be T2 (e.g., 140° C.), the temperature T1 is higher than the temperature T2 (T1>T2).

A fourth embodiment of the present invention will be explained as follows. The fourth embodiment of the present invention is embodied likewise the first embodiment of the present invention except some changes. The intermediate lamination layer body 25 transferring the catalyst electrode layer 14 for the oxidant electrode and the catalyst electrode layer 18 for the fuel electrode is placed in the homoeothermic furnace 27 for the heat treatment at the inactive gas ambient. The conditions are changed from the first through third embodiments. The temperature for the heat treatment of the fourth embodiment is determined to be higher than the first through third embodiments (e.g., 200° C.) and the time for the heat treatment is determined to be the same with the first through third embodiments (e.g., 10 minutes). The temperature for the heat treatment is determined to be at the temperature region equal to or greater than the glass-transition temperature of the electrolyte polymer included in the catalyst electrode layer 14 and the catalyst electrode layer 18 and equal to or less than the thermal decomposition temperature. The gas diffusion layers 10, 11 are not included in the intermediate lamination layer body 25 at the heat treatment. The pressure is not applied to the intermediate lamination layer body 25 at the heat treatment.

According to the fourth embodiment of the present invention, when the time for the heat treatment is determined to be t1 (e.g., 10 minutes) and the time for the hot pressing is determined to be t2 (e.g., 3 minutes), the time t1 is 10/3 times (approximately 3.3 times) to the time t2 (t1>t2). If the temperature for the beat treatment is determined to be T1 (e.g., 200° C.) and the temperature of the hot pressing is determined to be T2 (e.g., 140° C.), the temperature T1 is higher than the temperature T2 (T1>T2).

Some comparison examples will be explained as follows. A first comparison example is provided basically likewise the first embodiment of the present invention. With the first comparison example, the hot pressing is performed without performing the beat treatment. The conditions for the hot pressing are determined to be as follows likewise the first embodiment including the temperature at 140° C., the applied pressure at 8 MPa, and the time for 3 minutes.

A second comparison example is provided basically likewise the first embodiment of the present invention. With the second comparison example, the hot pressing is provided without performing heat treatment. The condition for the hot pressing is determined as follows including the temperature at 160° C., the pressure applied at 8 MPa, and the time for 3 minutes. In other words, the temperature of the hot pressing is increased to 160° C. According to the comparison example 2, the electrolyte membrane 20 is excessively deformed by the hot pressing to generate the cross leak of the gas of the electrolyte membrane 20. This disables to generate the electric power and the output potential could not be measured Accordingly, the hot pressing by the temperature of 160° C. is inappropriate because the electrolyte membrane 20 is deformed at the temperature of 160° C.

A fifth embodiment of the present invention will be explained referring to FIG. 2 as follows.

According to the fifth embodiment of the present invention, the catalyst paste likewise, the first embodiment is used. Further, gas diffusion layers 16B, 11B similar type of the gas diffusion layers 10, 11 treated with water repellent treatment is used (shown in FIG. 2A). The catalyst paste for the fuel electrode is applied to the outer surface of the gas diffusion layer 10B for the fuel electrode by doctor blade method to form an intermediate lamination layer body 32B including a catalyst electrode layer 18B for the fuel electrode (shown in FIG. 2B). The catalyst paste for the oxidant electrode is applied to the outer surface of the gas diffusion layer 11B for the oxidant electrode by the doctor blade method to form the intermediate lamination layer body 31B having a catalyst electrode layer 14B for the oxidant electrode (shown in FIG., 2B).

The intermediate lamination layer body 31B including the catalyst electrode layer 14B for the oxidant electrode and the intermediate lamination layer body 32B including the catalyst electrode layer 18B are placed in a homoeothermic furnace 27B. The intermediate lamination layer bodies 31B, 32B in the homoeothermic furnace 27B are heat treated at the inactive gas ambient and at the temperature of 160° C. without applying any pressure to the intermediate lamination layer bodies 31B, 32B in the thickness direction (shown in FIG. 2C).

As shown in FIG. 2C, the intermediate lamination layer body 31B, 32B are separated from the electrolyte membrane 20B at the heat treatment and the electrolyte membrane 20B is not included in the intermediate lamination layer body 31B, 32B. Because the intermediate lamination layer body 31B, 32B are heat treated under the foregoing condition, the heat transmission to the catalyst electrode layer 14B and catalyst electrode layer 18B is not prevented by the electrolyte membrane 20B. Accordingly, the heat transmission performance to the electrolyte polymer included in the catalyst electrode layer 14B and catalyst electrode layer 18B of the intermediate lamination layer body 31B and intermediate lamination layer body 32B is favorably maintained at the heat treatment and preferable heat treatment can be performed relative to the electrolyte polymer.

The temperature for the heat treatment is determined within the temperature region equal to or higher than the glass-transition temperature of the electrolyte polymer included in the catalyst electrode layers 14B, 18B and equal to or less than the thermal decomposition temperature. Thereafter, the intermediate lamination body 31B, 32B are removed from the homoeothermic furnace 27B.

The method for the hot pressing according to the fifth embodiment will be explained as follows. The electrolyte membrane 20B including an ion exchange membrane (thickness of 25μ, Dupont, Nafion 111) having the ion transmission is used. The intermediate lamination layer body 31B, 32B are positioned on the both sides of the electrolyte membrane 20B in the thickness direction. In this case, as shown in FIGS. 2D, 2E, an outer surface of the electrolyte membrane 20B is arranged to contact the outer surfaces of the catalyst electrode layer 14B catalyst and electrode layer 18B. An MEA 30B is produced by hot pressing a pattern 50c of a hot pressing pattern SOB under the conditions at the temperature of 140° C., with the pressure of 8 MPa, and for three minutes.

According to the fifth embodiment of the present invention, if a time t1 (e.g., 10 minutes) for heat treatment and a time t2 (e.g., three minutes) for hot pressing are determined, the time t1 is determined to be 10/3 (approximately 3.3 times) times relative to the time t2 (t1>t2). When the temperature for the heat treatment is determined to be T1 (e.g. 160° C.) and the temperature for the hot pressing is determined to be 12 (e.g., 140° C.), the temperature T1 is determined higher than the temperature T2 (T1>T2). With the fifth embodiment of the present invention, a pressure P1 is smaller than a pressure P2 when the pressure loaded to the intermediate lamination layer body 25B at the heat treatment is determined to be the pressure P1 (no pressure applied) and the pressure loaded to the intermediate lamination layer body 25B at the hot pressing is determined to be the pressure P2 (e.g., 8 MPa).

A sixth embodiment of the present invention is embodied likewise the fifth embodiment. The intermediate lamination layer body 31B including the catalyst electrode layer 14B for the oxidant electrode and the intermediate lamination layer body 32B including the catalyst electrode layer 18B for the fuel electrode are placed in the homoeothermic furnace 27B to be heat treated. The intermediate lamination layer body 31B and intermediate lamination layer body 32B are heat treated at the 160° C. for ten minutes in the homoeothermic furnace 27B. During the heat treatment is processed, the pressure of 8 MPA is applied to the intermediate lamination layer body 31B and the intermediate lamination layer body 32B in the thickness direction thereof by a tightening jig during the heat treatment. With the sixth embodiment, the electrolyte membrane 20B is not laminated on the intermediate lamination layer body 25B and the intermediate lamination layer body 32B at the heat treatment as shown in FIG. 2C. Accordingly, even if the pressure is applied to the intermediate lamination layer body 31B and the intermediate lamination layer body 32B, the electrolyte membrane 20B is not damaged. Thus, the degree of the pressure applied to the intermediate lamination layer body 31B and the intermediate lamination layer body 32B in the thickness direction can be determined without considering the influence on the electrolyte membrane 20B.

The temperature (e.g., 160° C.) of the heat treatment is determined in the temperature region equal to or higher than the glass-transition temperature of the electrolyte polymer include in the catalyst electrode layer 14B and the catalyst electrode layer 18B and equal to or less than the thermal decomposition temperature.

According to the sixth embodiment of the present invention, when a time t1 (e.g., 10 minutes) for the heat treatment and a time t2 (e.g., 3 minutes) for the hot pressing are determined the time t1 is 10/3 times (i.e., approximately 3.3 times) relative to the time t2 (t1>t2). When the temperature of the heat treatment is determined to be the temperature T1 (e.g., 160° C.) and the temperature of the hot pressing is determined to be the temperature T2 (e.g. 140° C.), the temperature T1 is higher than the temperature T2 (T1>T2). When the pressure loaded on the intermediate lamination layer body 31B and the intermediate lamination layer body 32B at the heat treatment is determined to be a pressure P1 (e.g., 8 MPa) and the pressure loaded on the intermediate lamination layer body 31B and the intermediate lamination layer body 32B at the hot pressing is determined to be a pressure P2 (e.g., 8 MPa), the pressure P1 is equal to the pressure P2.

The gas diffusion layers 10B, 11B constructing the intermediate lamination layer body 31B and the intermediate lamination layer body 32B are formed with the carbon paper corresponding to the assembly of the carbon fibers. The small concave and convex are formed on the outer surface of the gas diffusion layers 10B, 11B depending of the sorts of the carbon fibers. When the concave and the convex on the outer surface of the gas diffusion layers 10B, 11B are large and the applied pressure at the hot pressing is large, the convex and the concave of the gas diffusion layers 10B, 11B may damage the electrolyte membrane 20B. According to the sixth embodiment of the present invention, because the pressure is applied to the intermediate lamination layer body 31B and the intermediate lamination layer body 32B in the thickness direction at the heat treatment before the hot pressing, the concave and the convex on the surface of the gas diffusion layers 10B, 11B is planarized. Thus, the damage on the electrolyte membrane 20B by the concave and the convex on the surface of the gas diffusion layers 10B, 11B are restrained at the hot pressing after the heat treatment.

A third comparison example will be explained as follows. The third comparison example is embodied likewise the fifth embodiment of the present invention. The hot pressing is applied without performing the heat treatment The hot pressing is performed under the following conditions likewise the fifth embodiment of the present invention including the temperature at 140° C., the pressure of 8 MPa, and the time for three minutes.

The output potential is measured in the following manner. Using the MEA 30, 30B according to the embodiments and comparison example, the solid polymer type fuel cell with a single cell are constructed. The cell temperature is determined to be 75° C., the air is supplied to the oxidant electrode at the normal pressure, and the imitation gas including 10 ppm CO (capacity factor 90%) is supplied to the fuel electrode at the normal pressure. The imitation gas corresponds to the gas modifying the natural gas. The power generation experiment is performed at the electric current density of 0.17 A/cm² and the cell electric voltage output (initial output potential, and the output potential after continuing 1000 hours power generation) is measured. The measured result is shown in Table 1.

TABLE 1

| | Initial output | Potential after |
|---|---|---|
| | potential V | elapse of 1000 h |
| First embodiment | 0.770 | 0.742 |
| Second embodiment | 0.770 | 0.755 |
| Third embodiment | 0.770 | 0.764 |
| Fourth embodiment | 0.770 | 0.763 |
| Fifth embodiment | 0.765 | 0.752 |
| Sixth embodiment | 0.765 | 0.758 |
| First comparison | 0.770 | 0.721 |
| example | | |
| Second comparison | No power | No power |
| example | generation | generation |
| Third comparison | 0.765 | 0.743 |
| example | | |

As shown in Table 1, the initial output of the embodiments 1-4 and the initial output of the first comparison example 1 are 0.770V and approximately the same degree. However, after the elapse of 1000 hours, the output potential of the first through fourth embodiments are ranged 0.742-0.764V and are higher than the output potential (0.721V) of the first comparison example.

The initial output of the fifth and the sixth embodiments and the initial output of the second comparison example are 0.765V and the same level. However, after the elapses of 1000 hours, the output potential of the third comparison example is 0.743V and low. On the other hand, the output potential of the fifth and the sixth embodiments are 0.752V and 0.758V and are higher than the third comparison example. Thus, the MEA 30, 30B of the embodiments formed with the method of the present invention can maintain the high output potential after the long power generation compared to the comparison examples. It is considered because the effusion of the electrolyte polymer including the ion conductivity included in the catalyst electrode layer 14, 18 is restrained.

Although the carbon paper is used as the base member of the gas diffusion layer in the foregoing embodiments, the material is not limited and carbon cloth may be used.

According to the embodiments of the present invention, the output potential after the elapses of long power generation can be maintained at high level while maintaining the high initial output potential and the duration can be increased.

According to the method of the present invention, the catalyst electrode layer of the intermediate lamination layer body is heat treated while the electrolyte membrane is not laminated on the intermediate lamination layer body. Thus, the damage of the electrolyte membrane can be prevented when heating the intermediate lamination layer body at the heat treatment and when high pressure is applied to the intermediate lamination layer body.

According to the embodiments of the present invention, the intermediate lamination layer is heat treated by maintaining at the temperature range equal to or higher than the glass transition temperature of the electrolyte polymer included in the catalyst electrode layer and equal to or lower than the thermal decomposition temperature before hot pressing process. Thus, the crystallization of the electrolyte polymer included in the catalyst electrode layer is promoted to promote the solidity thereof. This contributes to decrease the solubility of the electrolyte polymer into the generated water or the humidification water. Thus, the effusion of the electrolyte polymer having the ion conductivity included in the catalyst electrode layer is restrained even if the generated water and the humidification water influences at the usage of the solid polymer type fuel cell.

The time for heat treatment may be determined ranged from one or two minutes to 12 or 24 hours depending on the temperature of the heat treatment, materials of the electrolyte polymer included in the catalyst electrode layer, and required manufacturing cost. Accordingly, the time for heat treatment may be varied one minute to 24 hours, one and a half minutes to 24 hours, 22 minutes to 12 hours, two minutes to 5 hours, two minutes to one hour, or the like. The heating temperature at the heat treatment is determined at the temperature region equal to or higher than the glass-transition temperature of the electrolyte polymer included in the catalyst electrode layer and equal to or lower than the thermal decomposition temperature in order to restrain the deterioration of the electrolyte polymer and for favorable crystallization of the electrolyte polymer. If necessary, the heat treatment may be performed at the glass-transition temperature or at the temperature region higher than the glass-transition temperature by 40° C., by 80° C., or by 100° C.

According to the embodiment of the present invention, preferably the heat treatment is performed under a state that the pressure is not applied to the intermediate lamination body. When the pressure is not applied to the intermediate lamination body, the damage on the electrolyte membrane at the heat treatment can be securely restrained. In addition, the heat treatment can be performed while applying the pressure on the intermediate lamination body in the thickness direction when the applied pressure at the heat treatment is small, because the damage on the electrolyte membrane can be prevented.

In case the pressure is applied to the intermediate lamination body during the heat treatment in the thickness direction, the draw effect of the electrolyte polymer included in the catalyst electrode layer may be observed to increase the crystallization and to reduce the solubility of the electrolyte polymer into the generated water and the humidification water. The pressure may be determined 0.1-20 MPa, 0.1-15 Mpa, 0.2-10 Mpa, 05-10 Mpa, or the like. According to the embodiments of the present invention, the pressure is determined not to damage the electrolyte because the lamination body includes the electrolyte membrane.

According to the embodiments of the present invention, the heat transmission to the catalyst electrode layer is not blocked by the gas diffusion layer because the thermal treatment of the intermediate lamination body is performed without stacking the gas diffusion layer on the intermediate lamination body. Thus, the heat transmission to the electrolyte polymer included in the catalyst electrode layer of the intermediate lamination body is favorably ensured during the heat treatment and the heat treatment relative to the electrolyte polymer is favorably performed.

According to the embodiments of the present invention, the heat treatment may be performed in the heat treatment oven at the inactive ambient or at the atmosphere. This enables to perform favorable heat treatment of the intermediate lamination body. The inactive ambient may include nitrogen ambient, argon gas ambient, nitrogen enrichment ambient, argon gas enrichment ambient, or the like.

The time for the heat treatment may be determined longer than the time for hot pressing. This ensures the heat transmission to the electrolyte polymer included in the catalyst electrode layer, the crystallization of the electrolyte polymer is promoted, and the solidity of the electrolyte polymer is promoted to favorably heat treating the intermediate lamination body.

According to the embodiments of the present invention, because the intermediate lamination body is heat treated under the state that the electrolyte membrane is not laminated on the intermediate lamination body the heat transmission to the catalyst electrode layer is not blocked by the electrolyte membrane. Accordingly, the heat transmission to the electrolyte polymer included in the catalyst electrode layer of the intermediate lamination body at the heat treatment is ensured to favorably perform the heat treatment relative to the electrolyte polymer.

According to the embodiments of the present invention, the heat treatment may be performed under the states that the pressure is not applied to the intermediate lamination body or that the pressure is applied to the intermediate lamination body in the thickness direction.

According to the embodiments of the present invention, the heat treatment of the catalyst electrode layer of the intermediate lamination body is performed under the state that the electrolyte membrane is not laminated on the intermediate lamination body. Thus, the damage on the electrolyte membrane is prevented even if the pressure is applied to the intermediate lamination body during the heat treatment.

According to embodiments of the present invention, the conductive miniature body may include carbon black, activated carbon, graphite, or the like. The catalyst may include at least one of platinum, rhodium, palladium, ruthenium or the like. The electrolyte polymer having the ion conductivity may include the fluorine carbide electrolyte polymer.

The principles, preferred embodiment and mode of operation of the present invention have been described in the foregoing specification. However, the invention which is intended to be protected is not to be construed as limited to the particular embodiments disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A method for manufacturing a membrane electrode assembly for a solid polymer type fuel cell comprising:
a process for forming an intermediate lamination layer body by laminating a catalyst electrode layer formed with a mixture including electrolyte polymer having the ion conductivity and a conductive miniature body including a catalyst on an electrolyte membrane including an ion conductivity;
a process for hot pressing for forming the membrane electrode assembly to unify the intermediate lamination layer body and porous gas diffusion layers positioned on both sides on the intermediate lamination layer body in a thickness direction; wherein
the intermediate lamination layer body is heat treated by maintaining heating at a temperature range equal to or higher than a glass-transition temperature of the electrolyte polymer included in the catalyst electrode layer and equal to or lower than thermal decomposition temperature before the hot pressing process under a condition that the gas diffusion layers are not laminating on the intermediate lamination layer body.

2. A method for manufacturing a membrane electrode assembly for a solid polymer type fuel cell according to claim 1, wherein the heat treatment is performed in a heat treatment oven either at an inactive ambient or at an atmosphere.

3. A method for manufacturing a membrane electrode assembly for a solid polymer type fuel cell according to claim 1, wherein the heat treatment is performed at a state that a pressure is not applied to the intermediate lamination layer body in a thickness direction.

4. A method for manufacturing a membrane electrode assembly for a solid polymer type fuel cell according to claim 1, wherein a time for heat treatment is predetermined longer than a time for the hot pressing.

5. A method for manufacturing a membrane electrode assembly for a solid polymer type fuel cell comprising:
a process for forming an intermediate lamination layer body by laminating a catalyst electrode layer formed with a mixture of an electrolyte polymer having the ion conductivity and a conductive miniature body including a catalyst on a porous gas diffusion layer;
a process for hot pressing for forming a membrane electrode assembly by unifying an electrolyte membrane having the ion conductivity and the intermediate lamination layer bodies arranged both sides of the electrolyte membrane; wherein
the intermediate lamination layer body is heat treated by maintaining heating at a temperature range equal to or higher that glass-transition temperature of the electrolyte polymer included in the catalyst electrode layer and equal to or lower than the thermal decomposition temperature before the process of hot pressing under a condition that the electrolyte membrane is not laminated on the intermediate lamination layer body.

6. A method for manufacturing a membrane electrode assembly for a solid polymer type fuel cell according to claim 5, wherein the heat treatment is performed in a heat treatment oven either at an inactive ambient or at an atmosphere.

7. A method for manufacturing a membrane electrode assembly for a solid polymer type fuel cell according to claim 5, wherein the heat treatment is performed at a state that a pressure is not applied to the intermediate lamination layer body in a thickness direction.

8. A method for manufacturing a membrane electrode assembly for a solid polymer type fuel cell according to claim 5, wherein a time for heat treatment is predetermined longer than a time for the hot pressing.
